(19) United States
(12) Patent Application Publication
(10) Pub. No.: US 2003/0045262 A1
(43) Pub. Date: Mar. 6, 2003

(54) Waveguide mixer/coupler

(76) Inventor: Mark J. Vaughan, San Jose, CA (US)

Correspondence Address: Steven J. Adamson, PC, P.O. Box 5997, Portland, OR, 97228, US

(21) Appl. No.: 09/946,972

(22) Filed: Sep. 4, 2001

(51) Int. Cl. H04B 1/26

(52) U.S. Cl. 455/323; 455/325

(57) ABSTRACT

A compact waveguide coupler or mixer having and an input, an output and a plurality of transmission segments coupled between the input and output. The transmission segments are preferably formed such that at least one is configured in a transmission media that permits conductor switching to achieve a phase shift. In a preferred embodiment, this media is slot line strip and the at least one conductor has a quarter wavelength and includes a conductor switch that achieves a 180 degree phase shift, thereby forming, in combination, a conduction segment that induces an approximately 270 degree phase shift. Various compact conductor arrangements are presented as are mixer and coupler embodiments.

### FIELD OF THE INVENTION

The present invention relates to coupling and mixing devices for electromagnetic energy transmission media. The present invention further relates to compact coupler and mixer designs that support high frequency, e.g., microwave and millimeter wave, signal propagation.

### BACKGROUND OF THE INVENTION

Various electromagnetic energy coupling and mixing devices are known in the art. They include rat race couplers and single balanced and double balanced mixers.

A rat race coupler is typically a device that has four transmission segments between four ports. Three of the transmission segments have a length of ¼ of a design wavelength (90° phase shift) and the remaining transmission segment has a length of ¾ wavelength of the design frequency (270° phase shift). An example of a rat race device may be found in The RF and Microwave Circuit Design Cookbook by Stephen A. Maas, Arttech House, Inc., 1998 p.104.

A single balanced mixer is generally a coupler with a pair of diodes connected between the signal and return conductors or between conductors and ground in such a manner as to achieve non-linear mixing. A rat race coupler with a pair of diodes connected in this manner is an example of a single balanced mixer. A double balanced mixer typically includes four diodes.

An example of a single balanced mixer may be found in a paper by Hsu et al, entitled Design and Performance of a New Uniplanar Diode Mixer, IEEE Microwave and Guided Wave Letters, vol 10, no. 5, May 2000, p. 192. An example of a double balanced mixer may be found in U.S. Pat. No. 5,265,266 issued to Trinh on Nov. 23, 1993, for a Resistive Planar Star Double-Balanced Mixer.

While existing coupling and mixing devices have made beneficial contributions to the art, they also have disadvantageous aspects. These disadvantageous aspects include, but are not limited to, designs that are undesirably expansive and/or expensive. From an expansive standpoint, prior art teachings are replete with designs that use semi-infinite ground planes. The use of semi-infinite ground planes and the like results in higher material costs (which may be considerable because, for example, gold is often used as a conductor) and higher manufacture and space allocation costs. The prior art designs are also disadvantageous in that they fail to utilize more compact arrangements for achieving the 270 degree transmission segment.

In addition to the 270 degree transmission segment being undesirably long, this segment is also disadvantageous in that it limits the bandwidth of signals for which the coupler functions. This is because the 270 degree (or ¾ wavelength) transmission line is designed with respect to a given design frequency and bandwidth is inversely related to the length of the line. It is desirable to produce an alternative arrangement for this segment that is less bandwidth limiting.

The need thus exists for more compact and less expensive electromagnetic energy coupling and mixing devices.

### SUMMARY OF THE INVENTION

Accordingly, it is an object of the present invention to provide a compact waveguide transmission media mixer/coupler design.

It is another object of the present invention to provide a compact mixer/coupler design using strip format transmission media.

It is also an object of the present invention to arrange the strip conductors in such a manner as to support greater bandwidth and to achieve phase shifts in such a manner as to facilitate more compact device design.

These and related objects of the present invention are achieved by use of a strip format waveguide mixer/coupler as described herein.

In one embodiment, the present invention includes an input, an output and a plurality of transmission segments coupled between the input and output. One of those transmission segments is configured in slot line strip with a switched conductor arrangement that achieves an approximately 180 degree phase shift. The transmission segment with the switched conductors preferably has a length of approximately one quarter wavelength of a design frequency so as to achieve in combination with the 180 degree phase shift a 270 degree phase shift for that transmission segment.

A diode may be coupled to at least one of the plurality of transmission segments. Other aspects of this embodiment include that the plurality of transmission segments includes a transmission segment other than said switched conductor segment that is formed of slot line strip or coupled slot line transmission media and at least one of said input or said output is formed of coplanar waveguide transmission media. Two diodes may be coupled to the plurality of transmission segments in such a manner as to facilitate mixing, and an IF filter may be coupled to said plurality of transmission segments.

Another embodiment of the present invention includes an input, an output, a first slot line strip conductor pair coupled between said input and said output and a second slot line strip conductor pair coupled between said input and said output. A portion of the strip conductor pair in the second slot line are preferably switched relative to one another in such a manner as to induce an approximately 180 degree phase shift. This embodiment may be further configured for coupling or mixing applications.

Yet another embodiment of the present invention includes an input, an output, a coupled slot line conductor coupled to one of said input and output, and a first slot line transmission segment and a second slot line transmission segment coupled between said coupled slot line and the other of said input and output. One of the first and second transmission segments is preferably configured in slot line strip with a switched conductor arrangement, the switched conductor arrangement achieving an approximately 180 degree phase shift. This embodiment may be further configured for coupling or mixing applications.

The attainment of the foregoing and related advantages and features of the invention should be more readily apparent to those skilled in the art, after review of the following more detailed description of the invention taken together with the drawings.

### BRIEF DESCRIPTION OF THE DRAWINGS

FIGS. 1-2 are a plan view and an equivalence type schematic diagram of a strip format waveguide mixer in accordance with the present invention.

FIG. 3 is a plan view of a strip format waveguide coupler in accordance with the present invention.

FIGS. 4A-4B are plan views of two other compact mixer/coupler embodiments in accordance with the present invention.

### DETAILED DESCRIPTION

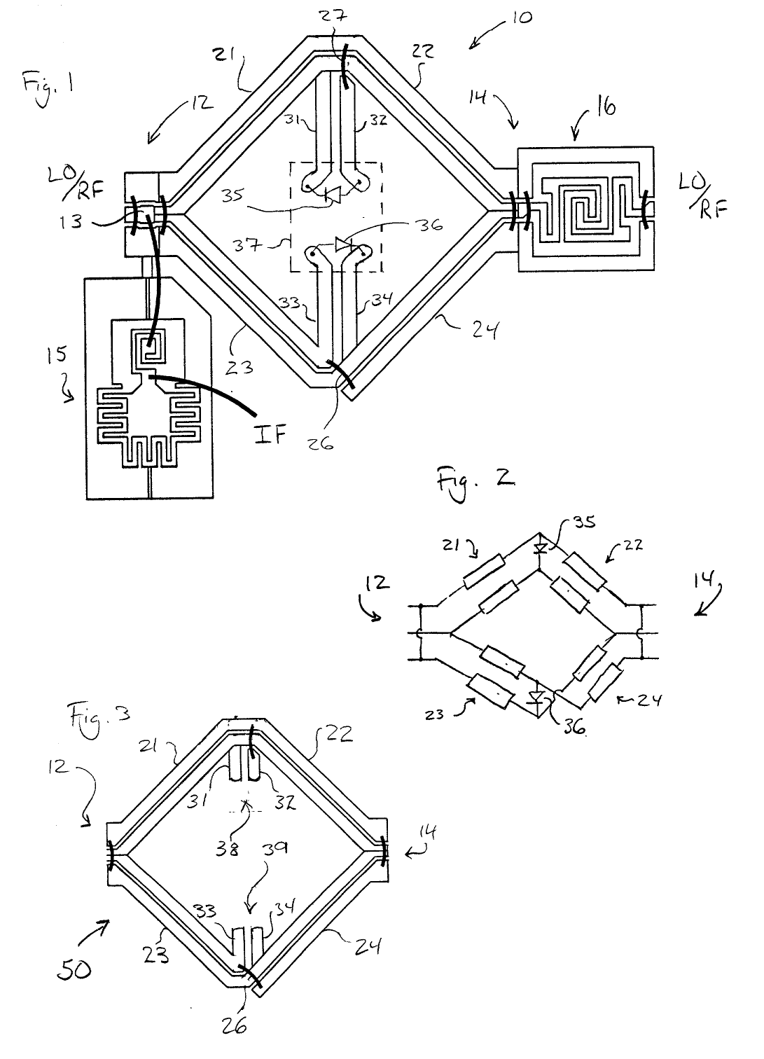

Referring to FIGS. 1-2, a plan view and an equivalence type schematic diagram of a strip format waveguide mixer 10 in accordance with the present invention are respectively shown. Mixer 10 preferably utilizes a combination of slot line strip and coplanar waveguide (CPW) strip transmission media to realize a compact design. The mixer is comprised of two principal ports 12,14 that may be used for input or output of LO or RF. These ports are preferably configured for coplanar waveguide (CPW) transmission (though CPW transmission media extending from these ports is not shown). IF is preferably taken off (in receive mode) or inserted (in transmit mode) at contact pad 13, though it may be taken out or inserted at any suitable location. Interdigitated filter 15 may be used for IF filtering.

FIG. 1 illustrates an interdigitated filter 15 coupled to contact pad 13 (to the IF tap). This filter is preferably configured to pass IF and to effectively not be seen by LO or RF signals. FIG. 1 also illustrates a filter 16 and port 14. Filter 16 is preferably configured to pass RF and LO, but to block passage of IF. Depending on a particular implementation of mixer 10, filter 16 may also be provided at port 12.

In the embodiment of FIGS. 1-2, mixer 10 has four primary transmission segments 21-24. These segments are preferably formed in slot line strip or the like. Three of the transmission segments 21-23 are preferably configured to achieve a 90 degree phase shift, while the fourth segment 24 is configured to achieve a 270 degree phase shift (in a compact manner). Note also that the transmission segment lengths could be longer by appropriate integer multiples of 90° lengths, though this results in a less compact device.

Each of the slot line strip transmission segments includes two conductors: signal and return. It is apparent from FIG. 1, that lead line 26 connects the interior conductive strip of segment 23 to the exterior conductive of segment 24. This “flip” or “switch” induces a 180 degree phase shift. The combination of this 180 degree phase shift with the 90 degree phase shift induced by the quarter-wave length of segment 24 achieves the desired 270 degree phase shift.

Appropriate diode connections to achieve a mixer are provided via conductors 31-34 respectively coupled between conductors 31,32 and 33,34. The diodes may be provided in an integrated circuit 37 (shown in phantom lines) and flip-mounted to the conductors or mounted by beam lead attachment or other suitable means. The length of conductors 31-34 may be varied to improve impedance matching looking into the diodes.

FIG. 2 illustrates an equivalence diagram of the transmission media layout shown in FIG. 1. Balanced transmission lines are illustrated in contrast, for example, to unbalanced transmission lines of the type used to represent microstrip transmission media. The rectangles represent the transmission line segments 21-24 and their 90 degree phase shifts (or their quarter-wave lengths). Diodes 35,36 are illustrated as being coupled between the signal conductor and the return conductor.

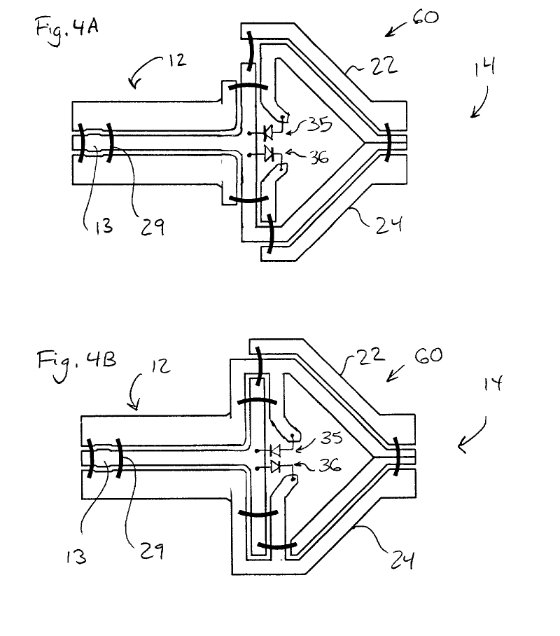

Referring to FIG. 3, a plan view of a strip format waveguide coupler 50 in accordance with the present invention is shown. Coupler 50 is similar to mixer 10 of FIG. 1, though the diodes are not provided and the conductor pairs 31,32 and 33,34 are preferably configured as ports 38,39, respectively, for coupling to or from other transmission lines (not shown). Segment 24 of coupler 50 preferably has the switched conductor.

It should be recognized that while ports 38,39 are indicated as being internally disposed in FIG. 3, these ports may, and often are, externally disposed. It should also be recognized that opposite ports 12,14 and 38,39 are isolated from one another and power is divided equally into adjacent ports. With respect to impedances, if the coupler/mixer is to be used in a 50-ohm system, then the characteristic impedances of the slot lines should be 71 ohms. More generally, if the coupler/mixer is designed for a Z₀-ohm system, then the characteristic impedances of the Z₀ times the square-root of 2.

Referring to FIGS. 4A-4B, plan views of two other compact mixer/coupler embodiments 60 in accordance with the present invention are shown. In FIG. 4A-B, the mixer 60 is achieved in a more compact manner by essentially forming segments 21,23 of FIG. 1 as a coupled slot line. The transmission line to the left of diodes 35,36 functions as a coupled slot line between the diodes and contact pad 13 (analogous to contact pad 13 of FIG. 1) and as CPW line to the left of the contact pad (i.e., to the left of the lead line 29 that connects the return conductors).

The spacing of lead line 29 and contact pads 13 from diode 35,36 is preferably that which achieves transmission line lengths analogous to those of segments 21,23 of FIG. 1.

FIGS. 4A-B illustrate two different arrangements of switched transmission segment 24. Segment 22 of mixer 60 is substantially as shown and described for mixer/coupler 10/50 of FIGS. 1 and 3. The diodes 35,36 may be provided as discussed above with reference to FIG. 1 to provide the mixing function. By eliminating diodes 35,36, however, mixer 60 functions as a coupler as discussed above.

It should be recognized that the switched conductors of segment 24 achieves a 180 phase shift that is substantially frequency independent. It should also be recognized that a double balanced mixer may be achieved using, for example, two of the mixers 10 or 60 described herein.

While the invention has been described in connection with specific embodiments thereof, it will be understood that it is capable of further modification, and this application is intended to cover any variations, uses, or adaptations of the invention following, in general, the principles of the invention and including such departures from the present disclosure as come within known or customary practice in the art to which the invention pertains and as may be applied to the essential features hereinbefore set forth, and as fall within the scope of the invention and the limits of the appended claims.

1. A waveguide coupler/mixer apparatus, comprising:
an input;
an output; and
a plurality of transmission segments coupled between said input and output;
wherein one of these transmission segments is configured in slot line strip with a switched conductor arrangement, said switched conductor arrangement achieving an approximately 180 degree phase shift.

2. The apparatus of claim 1, wherein said transmission segment with the switched conductors has a length of approximately one quarter wavelength of a design frequency so as to achieve in combination with said 180 degree phase shift a 270 degree phase shift for that transmission segment.

3. The apparatus of claim 1, further comprising a diode coupled to at least one of said plurality of transmission segments.

4. The apparatus of claim 1, wherein said plurality of transmission segments includes a transmission segment other than said switched conductor segment that is formed of slot line strip or coupled slot line transmission media.

5. The apparatus of claim 4, wherein at least one of said input or said output is formed of coplanar waveguide transmission media.

6. The apparatus of claim 1, wherein each of said transmission segments is formed of slot line strip or coupled slot line transmission media.

7. The apparatus of claim 4, further comprising two diodes coupled to said plurality of transmission segments in such a manner as to facilitate mixing.

8. The apparatus of claim 1, further comprising an IF filter coupled to said plurality of transmission segments.

9. A waveguide mixer/coupler apparatus, comprising:
an input;
an output;
a first slot line strip conductor pair coupled between said input and said output; and
a second slot line strip conductor pair coupled between said input and said output;
wherein a portion of the strip conductor pair in the second slot line are switched relative to one another in such a manner as to induce an approximately 180 degree phase shift.

10. The apparatus of claim 9, wherein said portion of said second pair that includes said switched conductors has a length of approximately a quarter of a wavelength of a design frequency so that in combination with said approximately 180 degree phase shift produces a phase shift of 270 degrees.

11. The apparatus of claim 9, wherein each of said first and second conductor pairs includes a signal conductor and a return conductor, and a diode is provided coupled to the signal and return conductors of at least one of said pairs in such a manner as to facilitate mixing.

12. The apparatus of claim 9, wherein said first slot line includes two transmission segments each having a length of approximately one quarter wavelength of a design frequency and said second slot line includes said switched portion and another transmission segment having a length of approximately one quarter wavelength of a design frequency.

13. A waveguide mixer/coupler apparatus, comprising:
an input;
an output;
a coupled slot line conductor coupled to one of said input and output; and
a first slot line transmission segment and a second slot line transmission segment coupled between said coupled slot line and the other of said input and output;
wherein one of said first and second transmission segments is configured in slot line strip with a switched conductor arrangement, said switched conductor arrangement achieving an approximately 180 degree phase shift.

14. The apparatus of claim 13, wherein said transmission segment with the switched conductors has a length of approximately one quarter wavelength of a design frequency so as to achieve in combination with said 180 degree phase shift a 270 degree phase shift for that transmission segment.

15. The apparatus of claim 13, further comprising a diode coupled to at least one of said plurality of transmission segments to facilitate mixing.
